(19) United States
(12) Patent Application Publication
(10) Pub. No.: US 2012/0179383 A1
(43) Pub. Date: Jul. 12, 2012

(54) DISC AND CALIBRATION METHOD OF TEST DEVICE USING THE SAME

(75) Inventors: Yeong Bae YEO, Seoul (KR); Ki Ju LEE, Suwon-si (KR)

(73) Assignee: SAMSUNG ELECTRONICS CO., LTD, Suwon-si (KR)

(21) Appl. No.: 13/344,279

(22) Filed: Jan. 5, 2012

(30) Foreign Application Priority Data
Jan. 6, 2011 (KR) 10-2011-0001498

(51) Int. Cl. G06F 19/00; G12B 13/00

(52) U.S. Cl. 702/19; 73/1.01

(57) ABSTRACT

A disc for calibrating a measurement unit of a test device and a calibration method using the same are provided. The disc includes a calibration unit to calibrate a measurement unit of a biomaterial test device.

### CROSS-REFERENCE TO RELATED APPLICATION

This application claims priority from Korean Patent Application No. 10-2011-0001498, filed Jan. 6, 2011 in the Korean Intellectual Property Office, the disclosure of which is incorporated herein by reference.

### BACKGROUND

1. Field

Apparatuses and methods consistent with exemplary embodiments relate to a disc and a calibration method of a test device using the same. More specifically, exemplary embodiments relate to a disc for calibration to calibrate a measurement unit of a test device and a calibration method of the test device using the same.

2. Description of the Related Art

A test device to test biomaterials includes a measurement unit to detect the concentration of a biomaterial (i.e., the test target). Biomaterials of the same type and same concentration should output the same test results. However, the differences in test devices, in elements constituting measurement units, or in test conditions may cause differences deviating from an acceptable error range of the test results. This problem may cause deterioration in reliability of test results.

Accordingly, in order to increase the reliability of test results, a criterion to calibrate the measurement results of the measurement unit is required.

### SUMMARY

Exemplary embodiments provide a disc to calibrate a measurement unit of a test device, and a calibration method of the test device using the same.

In accordance with an aspect of an exemplary embodiment, there is provided a disc for calibrating a biomaterial test device, the disc including a calibration unit to calibrate a measurement unit of the biomaterial test device.

The calibration unit may calibrate a fluorescent analysis unit provided in the biomaterial test device.

The calibration unit may include: a plurality of calibration samples, and a plurality of chambers to accept the plurality of calibration samples.

The chambers may include a plurality of areas having different volumes.

The chambers may be formed in a concentric circle.

The chambers may include a plurality of media, each having different transmissive or reflective properties.

Each medium may be interposed between the fluorescent analysis unit and the calibration sample.

The calibration sample may include a fluorescent material.

The plurality of calibration samples may have different concentrations.

The calibration unit may calibrate a camera module provided in the biomaterial test device.

The calibration unit may include at least one reaction paper provided with a plurality of strips with different brightnesses.

The at least one reaction paper may be produced by printing with a plurality of strips with different brightnesses on the disc.

In accordance with an aspect of another exemplary embodiment, there is provided a calibration method using a test device, the calibration method including: measuring a disc including a calibration unit using a standard test device; measuring the disc using a calibration test device; obtaining a correlation between the measured results of the standard test device and the measured results of the calibration test device; storing the correlation in the calibration test device; and calibrating the test results of biomaterials using the correlation.

The measuring the disc may be carried out by measuring fluorescence of the fluorescent material present in the calibration unit of the disc.

The measuring the disc may be carried out by measuring brightness of the reaction paper present in the calibration unit of the disc.

The measuring the disc may be carried out by measuring fluorescence of the fluorescent material present in the calibration unit of the disc.

The measuring the disc may be carried out by measuring the brightness of the reaction paper present in the calibration unit of the disc.

The test device may include a fluorescent analysis unit.

The calibration unit may include a fluorescent material.

The test device may include a camera module.

The calibration unit may include a reaction paper provided with a plurality of strips, each having a different brightness.

### BRIEF DESCRIPTION OF THE DRAWINGS

The above and/or other aspects will become apparent and more readily appreciated from the following description of exemplary embodiments, taken in conjunction with the accompanying drawings of which:

FIG. 1 is a schematic view illustrating the configuration of a test device according to an exemplary embodiment;

FIG. 2 is a conceptual view schematically illustrating the configuration of a calibration disc according to an exemplary embodiment;

FIG. 3 is a conceptual view schematically illustrating the configuration of the chamber of a calibration disc according to an exemplary embodiment;

FIG. 4 is a flowchart illustrating a calibration method of a test device according to an exemplary embodiment;

FIG. 5 is a schematic view illustrating the configuration of a test device according to another exemplary embodiment;

FIGS. 6A and 6B are schematic views illustrating the configuration of a calibration disc according to another exemplary embodiment; and

FIG. 7 is a flowchart illustrating a calibration method of a test device according to another embodiment.

### DETAILED DESCRIPTION

Reference will now be made in detail to exemplary embodiments, examples of which are illustrated in the accompanying drawings, wherein like reference numerals refer to like elements throughout.

Hereinafter, aspects and features of the inventive concept and methods to accomplish the same will be more easily understood from the detailed description and the annexed drawings. However, one or more exemplary embodiments can be realized in a variety of forms and are not limited to the above-mentioned exemplary embodiments.

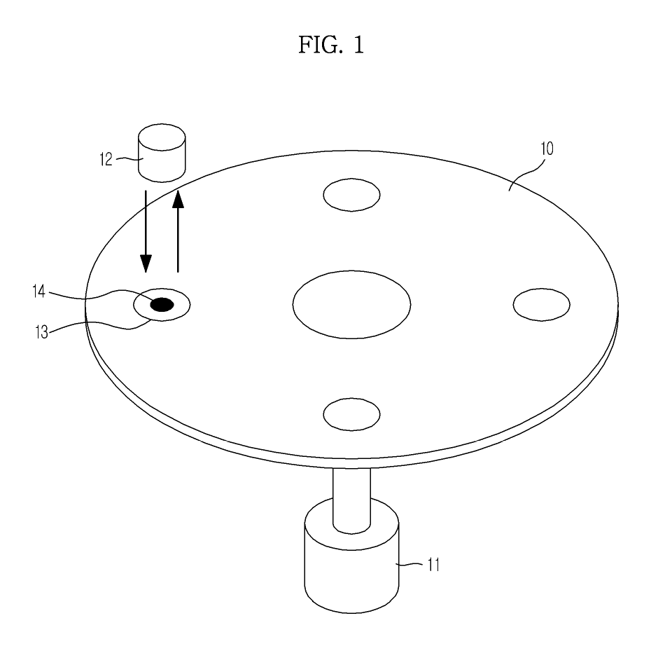

FIG. 1 is a schematic view illustrating the configuration of a test device according to an exemplary embodiment.

A test device means a device to analyze or test a variety of samples (i.e., analytes). The type of test device may be varied depending on the type of sample, the target to be analyzed, etc.

Exemplary samples include, but are not limited to, DNA, oligonucleotides, RNA, PNA, ligands, receptors, antibodies, antibodies, milk, urine, saliva, hairs, crop samples, meat samples, fish samples, livestock samples, processed food samples, oral cells, tissue samples, semen, proteins and other biomaterials. Exemplary analytes include, but are not limited to, proteins, antibodies, antigens, DNA, RNA, oligonucleotides, receptors and the like. For example, when urine is used as a sample, the analyte may be blood, glucose, ascorbic acid, ketones, proteins, saccharides, urobilinogen, bilirubin and the like.

Hereinafter, a blood tester to analyze a blood sample will be described as one example of such test devices, but the technical concept of the present invention is not limited thereto.

As shown in FIG. 1, the test device according to one embodiment includes a calibration disc 10 provided with at least one chamber 13, which includes therein a calibration sample 14, a rotation driving member 11 to rotate the disc and a photodetector 12 to detect light generated from the calibration sample 14 of the calibration disc 10.

The at least one chamber 13 may be provided in a concentric circle around the disc such that the chamber 13 corresponds to the photodetector 12.

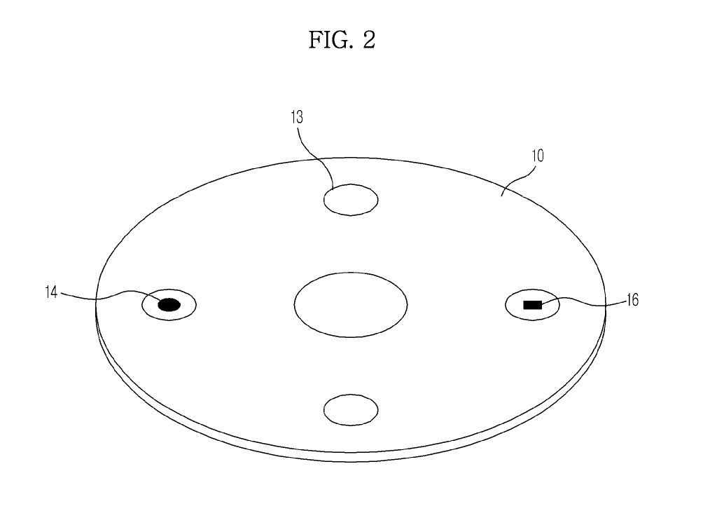

The chamber 13 may directly accept the calibration sample 14 or provide a position at which other media may be provided with the calibration sample 14. For example, the calibration sample 14 need not be directly inserted into the chamber 13, but rather, a fluorescent glass 16 may be provided as the calibration sample 14 in the chamber 13 (see FIG. 2).

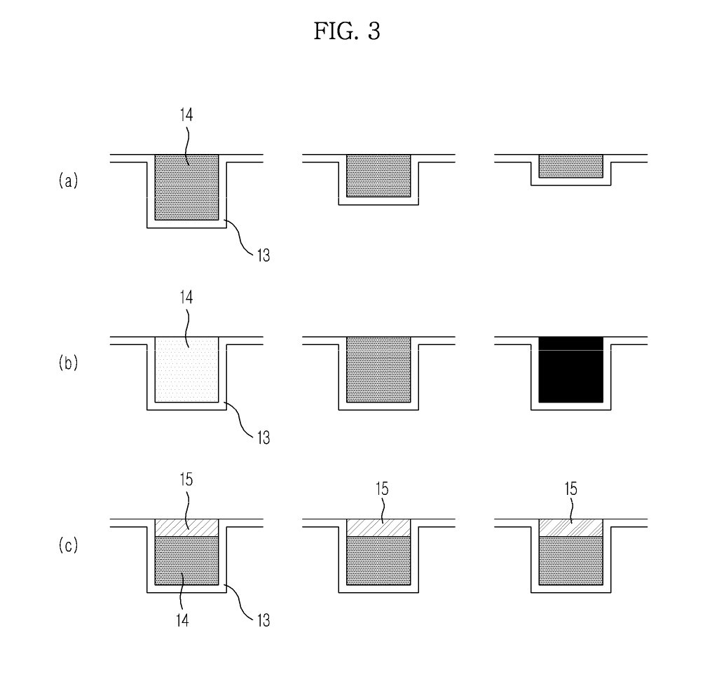

Each of the at least one chambers 13 may have different volumes to accept different volumes of calibration samples 14 (see FIG. 3A). Although reagents having the same concentration are typically used, the use of chambers 13 having different volumes may provide similar results to those resulting from use of reagents having different concentrations.

The calibration sample 14 may be a liquid or solid fluorescent material which has an excitation spectrum and output spectrum sufficiently overlapping the excitation spectrum and an output spectrum of fluorescent markers used for testing of biomaterials. In addition, a calibration sample 14 may be used at different concentrations within the at least one chamber 13 (see FIG. 3B). When a variety of concentrations of the fluorescent material are used as the calibration sample 14 for testing biomaterials, the concentrations may match those of the fluorescent markers, and thus be used for calibrating the detected results. Examples of fluorescent markers used for testing biomaterials include, but are not limited to, europium chelate particles, in which case the photodetector 12 may utilize a UV wavelength of light as an excitation light source and output light may be detected at about 610 nm. To calibrate the detected results, a fluorescent glass including europium may be used as the calibration sample 14. An exemplary fluorescent glass is Lumilass Glass R7, which is commercially available from Sumita Corp.

The calibration sample 14 may be disposed together with at least one medium 15 in the at least one chamber 13 (see FIG. 3C). The media 15 disposed within the chamber 13 are materials having different transmissive and/or reflective properties, and may be arranged between the calibration sample 14 and the photodetector 12.

The concentrations of the fluorescent materials may match a variety of concentrations of fluorescent markers used for testing biomaterials. In an exemplary embodiment, the a plurality of calibration samples 14, each having different volumes is injected into a plurality of chambers 13 of the same volume (see FIG. 3B). In another exemplary embodiment, a plurality of calibration samples 14, each having the same concentration is injected into a plurality of chambers 13 having different volumes (see FIG. 3A). In another exemplary embodiment, a plurality of calibration samples 14, each having the same concentration, are individually combined with a plurality of media having different transmissive and/or reflective properties, and injected into a plurality of chambers 13 of the same volume (see FIG. 3C).

The rotation driving member 11 may stop or rotate the disc such that the chamber 13 reaches a predetermined position of the disc.

The rotation driving member 11 may include a motor drive device (not shown) to control an angular position of the disc. For example, the motor drive device may be a stepper motor or a direct current motor.

The photodetector 12 may be arranged such that it faces the front surface of the calibration disc. In particular, the photodetector 12 may be arranged such that it faces a chamber 13 on the disc.

The photodetector 12 generates electric signals depending on the intensity of incident light. Examples of the photodetector 12 include, but are not limited to, depletion layered photodiodes, avalanche photodiodes (APDs), photomultiplier tubes (PMTs) and the like.

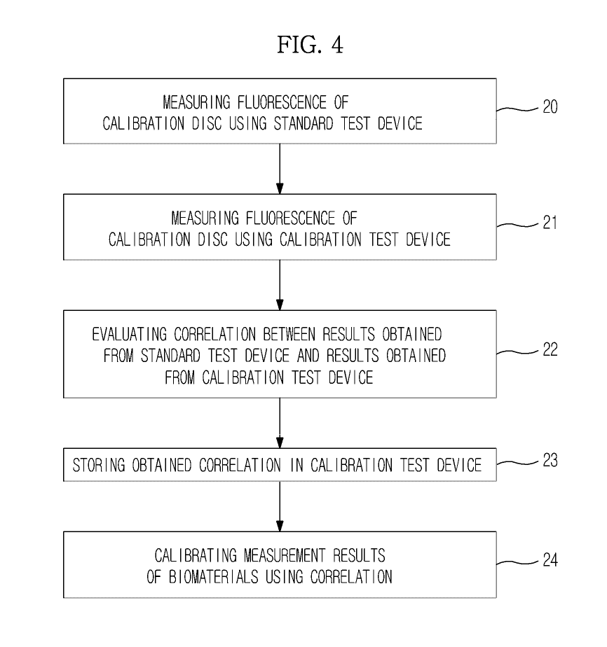

FIG. 4 is a flowchart illustrating a method for calibrating a test device using a calibration disc 10 according to an exemplary embodiment.

As shown in FIG. 4, fluorescence of the calibration disc 10 is measured using a standard test device (20). The standard test device means a test device that provides a base measurement, the results of which will be used to calibrate a test device. The calibration disc 10 is a disc which includes a plurality of calibration samples 14. The correlation between the concentration of the calibration samples 14 and the intensity of fluorescence is evaluated by measuring the fluorescence of multiple calibration samples 14, each having different concentrations, that are provided in a plurality of chambers 13 within the calibration disc 10.

The fluorescence of the calibration disc 10 is measured using a calibration test device (21). The calibration test device means a test device used to calibrate measurement results using the results obtained from the standard test device. The correlation between the concentration of the calibration samples 14 and the intensity of fluorescence is evaluated by measuring the fluorescence of calibration samples 14 having different concentrations provided in the plurality of chambers 13 of the calibration disc 10.

Correlation between results obtained from the standard test device and results obtained from the calibration test device is thereafter evaluated (22). For example, when the concentration of the calibration sample 14 used to obtain an intensity of fluorescence from the standard test device is different from the concentration of the calibration sample 14 used to obtain an intensity of the fluorescence from the calibration test device, the concentration of the calibration sample 14 used in the calibration test device may be calibrated using the concentration of the calibration sample 14 used in the standard test device at the same fluorescent intensity. That is, correlation between the concentration of the fluorescent material of the calibration test device and the concentration of the fluorescent material of the standard test device is obtained at the same fluorescent intensity using results obtained from the standard test device and the calibration test device.

The obtained correlation is then stored in the calibration test device (23) and is used for calibrating the results obtained from measuring a biomaterial using a fluorescent marker (24).

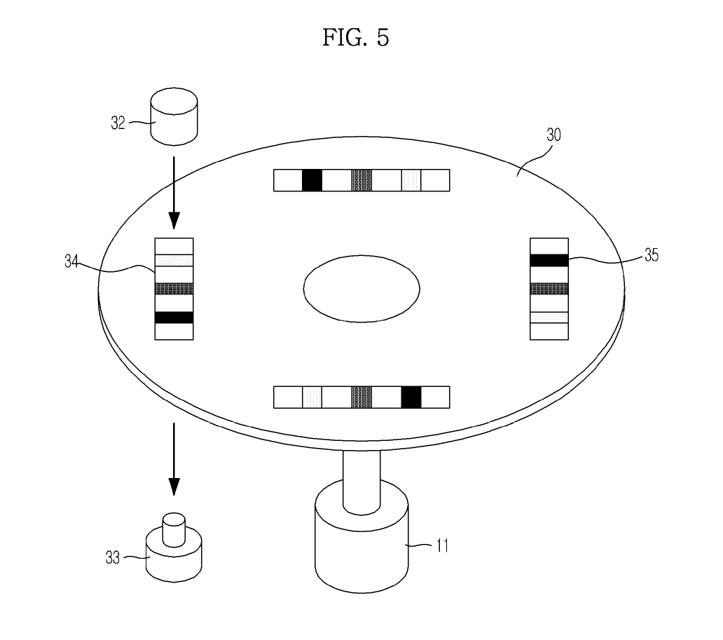

FIG. 5 is a diagram schematically illustrating a configuration of a test device 10 according to another exemplary embodiment.

As shown in FIG. 5, the test device according to another exemplary embodiment includes a calibration disc 30 provided with a reaction paper 34, a rotation driving member 11 to rotate the disc, a lighting member 32 to irradiate light to the reaction paper 34 of the calibration disc 30 and a camera module 33 to photograph the reaction paper 34 of the calibration disc 30.

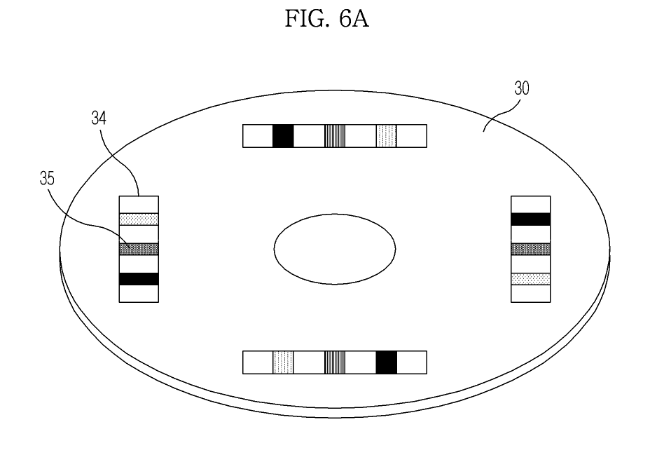

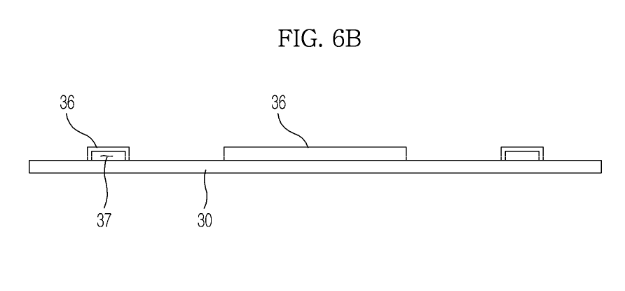

The calibration disc 30 may include at least one reaction paper 34 provided with a plurality of strips 35 having different brightnesses (see FIG. 6A). The calibration disc 30 may include an insertion structure 36 provided at the front surface thereof with a slit 37 to insert and remove the reaction paper 34 (see FIG. 6B). The insertion structure 36 may be provided at a position which corresponds to the photographing region of the camera module 33 of the test device.

In an exemplary embodiment, the reaction paper 34 may be adhered to the front surface of the calibration disc 30. The area where the reaction paper 34 is adhered may correspond to the photographing region of the camera module 33 and may be surface-processed to facilitate adhesion of the reaction paper 34.

In another exemplary embodiment, the reaction paper 34 provided with a plurality of strips 35 having different brightnesses may be printed on the calibration disc 30. When the reaction paper 34 is printed on the calibration disc 30, silk screen printing may be used to uniformly print the strips 35, but the printing method is not limited thereto.

The rotation driving member 11 stops or rotates the disc such that the reaction paper 34 reaches a predetermined position on the disc. The rotation driving member 11 may include a motor drive device (not shown) to control the angular position of disc. For example, the motor drive device may be a stepper motor or a direct current motor.

The camera module 33 may face the lighting member 32 such that the disc provided with the reaction paper 34 is interposed therebetween. In an exemplary embodiment, lighting member 32 may be arranged on the front surface of the disc and the camera may be arranged on the rear surface thereof. In another exemplary embodiment, the lighting member 32 may be arranged on the rear surface of the disc and the camera may be arranged on the front surface thereof. The camera module 33 and the lighting member 32 may be arranged at positions corresponding to the reaction paper 34 on the disc.

The lighting member 32 is a device which converts electrical or other energy into light energy to irradiate the strips 35 of the reaction paper 34 and examples thereof include, but are not limited to, incandescent lamps, halogen lamps, fluorescent lamps, mercury lamps, metal halide lamps, xenon lamps, light-emitting diodes, lasers and the like.

The camera module 33 photographs images of strips 35 using light which passes through the strips 35 of the reaction paper 34. Examples of the camera module 33 include, but are not limited to, complementary metal-oxide semiconductor (CMOS) cameras, charge-coupled device (CCD) cameras and the like.

Although not shown in the drawings, the lighting member 32 and the camera module 33 are connected to a support and are adhered to the test device. The support may be designed to slide in the diameter direction of disc. The support receives power from a feeding motor and thus shifts to a position corresponding to the reaction paper 34 on the disc, the lighting member 32 irradiates light to the reaction paper 34, and the camera module 33 photographs the reaction paper 34.

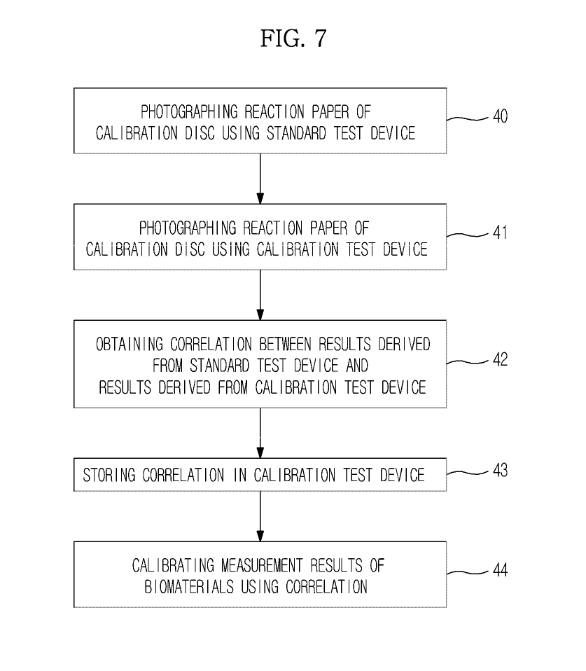

FIG. 7 is a flowchart showing a method for calibrating a test device using the calibration disc 30 according to an exemplary embodiment.

As shown in FIG. 7, the reaction paper 34 of the calibration disc 30 is photographed in the standard test device (40). The standard test device means a test device that provides measured standard results to the calibration target. The calibration disc 30 is a disc which includes at least one reaction paper 34 provided with a plurality of strips 35 having different brightnesses. The correlation between the brightnesses of the strips 35 and the value measured by the camera module 33 is obtained by photographing the strips 35 with different brightnesses that are provided in the reaction paper 34 of the calibration disc 30.

The reaction paper 34 of the calibration disc 30 is photographed by the calibration test device (41). The calibration test device means a test device which calibrates measured results using the results obtained from the standard test device. The correlation between the brightnesses of the strips 35 and the measured value by the camera module 33 is obtained by photographing the strips 35 on the reaction paper 34 of the calibration disc 30.

The correlation between the results derived from the standard test device and the results derived from the calibration test device is thereafter obtained (42). For example, when there is a difference between the measured value by the camera module 33 obtained from photographing the strips 35 using the standard test device and the measured value by the camera module 33 obtained from photographing the strips 35 using the calibration test device, at an identical brightness of strip 35, the measured value derived from the calibration test device can be calibrated using the measured value derived from the standard test device. That is, the correlation between the measured value from the standard test device and the measured value from the calibration test device is obtained at the same strip brightness using the obtained results.

The correlation thus obtained is stored in the calibration test device (43) and is then used for calibrating the results obtained from measuring biomaterials using a disc with a type of the reaction paper 34 (44).

As described above, use of the device and method according to the exemplary embodiments increase the reliability of the results obtained from the test device by calibrating the measurement unit provided in the test device.

Although exemplary embodiments have been shown and described, it would be appreciated by those skilled in the art that changes may be made in these exemplary embodiments without departing from the principles and spirit of the inventive concept, the scope of which is defined by the claims.

What is claimed is:

1. A disc for calibrating a biomaterial test device, the disc comprising a calibration unit to calibrate a measurement unit of the biomaterial test device.

2. The disc according to claim 1, wherein the calibration unit calibrates a fluorescent analysis unit provided in the biomaterial test device.

3. The disc according to claim 2, wherein the calibration unit comprises:
a plurality of calibration samples; and
a plurality of chambers configured to accept the plurality of calibration samples.

4. The disc according to claim 3, wherein the chambers have different volumes.

5. The disc according to claim 3, wherein the chambers are arranged in a concentric circle on the disc.

6. The disc according to claim 3, wherein the chambers include a plurality of media having different transmissive or reflective properties.

7. The disc according to claim 6, wherein each medium is interposed between the fluorescent analysis unit and the calibration sample.

8. The disc according to claim 3, wherein the calibration sample includes a fluorescent material.

9. The disc according to claim 3, wherein the plurality of calibration samples have different concentrations.

10. The disc according to claim 1, wherein the calibration unit calibrates a camera module provided in the biomaterial test device.

11. The disc according to claim 10, wherein the calibration unit includes at least one reaction paper provided with a plurality of strips with different brightnesses.

12. The disc according to claim 10, wherein the calibration unit is obtained by printing the reaction paper provided with a plurality of strips with different brightnesses on the disc.

13. A calibration method using a test device comprising, the calibration:
measuring a disc including a calibration unit using a standard test device;
measuring the disc using a calibration test device;
obtaining a correlation between results of the measuring the disc using the standard test device and results of the measuring the disc using the calibration test device;
storing the correlation in the calibration test device; and
calibrating test results of biomaterials tested with the calibration test device using the correlation.

14. The calibration method according to claim 13, wherein the measuring the disc using the standard test device comprises by measuring fluorescence of a fluorescent material present in the calibration unit of the disc.

15. The calibration method according to claim 13, wherein the measuring the disc using the standard test device comprises measuring brightness of a reaction paper present in the calibration unit of the disc.

16. The calibration method according to claim 13, wherein the measuring the disc using the calibration test device is comprises measuring fluorescence of a fluorescent material present in the calibration unit of the disc.

17. The calibration method according to claim 13, wherein the measuring the disc using the calibration test device is comprises measuring brightness of a reaction paper present in the calibration unit of the disc.

18. The calibration method according to claim 13, wherein the test device includes a fluorescent analysis unit.

19. The calibration method according to claim 18, wherein the calibration unit includes a fluorescent material.

20. The calibration method according to claim 13, wherein the test device includes a camera module.

21. The calibration method according to claim 20, wherein the calibration unit includes a reaction paper provided with a plurality of strips with different brightnesses.

22. The calibration method according to claim 15, wherein the reaction paper is provided with a plurality of strips with different brightnesses.

23. A calibration device comprising a disc having a front surface and a back surface, the disc comprising a plurality of chambers disposed on the front surface, and a plurality of calibration samples disposed within the plurality of chambers to calibrate a measurement unit of a biomaterial test device.

24. The calibration device according to claim 23, wherein the calibration samples include a fluorescent material for calibrating a fluorescent analysis unit of a biomaterial test device.

25. The calibration device according to claim 24, further comprising a plurality of media disposed over the calibration samples.

26. The calibration device according to claim 23, wherein each of the plurality of chambers has a different volume one another.

27. The calibration device according to claim 23, wherein each of the plurality of calibration samples has a different concentration from one another.

28. The calibration device according to claim 25, wherein each of the plurality of media has different transmissive or reflective properties from one another.

29. The calibration device according to claim 23, wherein the calibration samples comprise at least one reaction paper calibrating brightness of a camera unit.

30. The calibration device according to claim 29, wherein the reaction paper comprises a plurality of strips, each strip having a different brightness from one another.
